(19) United States
(12) Patent Application Publication
(10) Pub. No.: US 2023/0173597 A1
(43) Pub. Date: Jun. 8, 2023

(54) PORTABLE CUTTING MACHINE

(71) Applicant: MAKITA CORPORATION, Anjo-shi (JP)

(72) Inventor: Kenji HAMADA, Anjo-shi (JP)

(73) Assignee: MAKITA CORPORATION, Anjo-shi (JP)

(21) Appl. No.: 17/968,332

(22) Filed: Oct. 18, 2022

(30) Foreign Application Priority Data
Dec. 2, 2021 (JP) 2021-196058

(51) Int. Cl. B23D 59/00; B23D 45/16

(52) U.S. Cl. CPC B23D 59/006; B23D 45/16

(57) ABSTRACT

A dust case has improved operability for attachment and detachment. A portable cutting machine includes a cutting machine body to which a blade being circular is attachable, and a dust case detachably attached to the cutting machine body. The dust case includes a detachment operation unit pushable along an imaginary plane parallel to a surface of the blade in detachment from the cutting machine body, and a finger support including a surface frontward from the detachment operation unit in a pushing direction in which the detachment operation unit is pushed. The surface is substantially perpendicular to the pushing direction.

### CROSS-REFERENCE TO RELATED APPLICATIONS

This application claims the benefit of priority to Japanese Patent Application No. 2021-196058, filed on Dec. 2, 2021, the entire contents of which are hereby incorporated by reference.

### BACKGROUND

### 1. Technical Field

The present disclosure relates to a portable cutting machine called a metal cutter (a metal cutting saw) used for cutting, for example, iron plates.

### 2. Description of the Background

A portable cutting machine includes a circular cutting blade rotatable by a motor. To cut a workpiece, the blade being rotated is moved along a portion to be cut. Dust is blown upward from the portion at which the blade is cut into (cutting portion). The portable cutting machine can have various structures to avoid dispersion of blown dust into the surrounding area. For example, the portable cutting machine may include a stationary cover surrounding the blade to collect dust blown upward from the cutting portion and carried in the blow from the rotating blade. The dust collected in the stationary cover is guided into a dust bag or into a rectangular dust case for removal. The dust bag and the dust case are thus detachable from the cutting machine body.

A technique for an attachment and detachment structure of the dust case is described in Patent Literature. In the dust case described in Japanese Unexamined Patent Application Publication No. 2005-138220 (hereafter referred to as Patent Literature 1), a detachment operation unit is located on the back surface of the dust case opposite to the surface on which the dust case is attached. The dust case is fastened along the attachment surface with a rotary operation member engaged with the dust case from the back. The dust case is detached with the operation member rotated on the back surface and disengaged.

A dust case described in Japanese Unexamined Patent Application Publication No. 2009-154510 (hereafter referred to as Patent Literature 2) includes two finger holds on a side surface and a detachment button as a push button at the rear. With, for example, the thumb and the middle finger being on the two finger holds, the detachment button is pressed with the index finger to release the engagement tab from the body to detach the dust case.

### BRIEF SUMMARY

To attach or detach the dust case described in Patent Literature 1, the dust case is held with one hand, and the operation member is rotated with the other hand. In this manner, the operation is performed with both hands. The operability for attachment and detachment is to be improved.

For the dust case described in Patent Literature 2, the dust case is held with two fingertips, and the detachment button is to be pressed with another fingertip. The dust case cannot be supported with any finger in the direction in which the detachment button is pressed and thus may be unstable.

One or more aspects of the present disclosure are directed to a dust case with improved operability for attachment and detachment.

A first aspect of the present disclosure provides a portable cutting machine, including:
a cutting machine body to which a blade being circular is attachable; and
a dust case detachably attached to the cutting machine body, the dust case including
a detachment operation unit pushable along an imaginary plane parallel to a surface of the blade in detachment from the cutting machine body, and
a finger support including a surface frontward from the detachment operation unit in a pushing direction in which the detachment operation unit is pushed, the surface being substantially perpendicular to the pushing direction.

The structure according to the above aspect improves the operability in attaching and detaching the dust case.

### BRIEF DESCRIPTION OF DRAWINGS

FIG. 1 is an overall perspective view of a portable cutting machine with a dust case attached, as viewed obliquely from the right rear.

FIG. 2 is an overall perspective view of the portable cutting machine during detachment of the dust case, as viewed obliquely from the right rear.

FIG. 3 is a left side view of the dust case showing the inside.

FIG. 4 is a right side view of the portable cutting machine.

FIG. 5 is a top view of the portable cutting machine.

FIG. 6 is a top view of the portable cutting machine during detachment of the dust case.

FIG. 7 is a right side view of the portable cutting machine with the dust case detached.

FIG. 8 is a front view of the portable cutting machine as viewed in the direction indicated by arrow VIII in FIG. 4.

FIG. 9 is a left side view of the portable cutting machine as viewed in the direction indicated by arrow IX in FIG. 8.

FIG. 10 is a rear view of the portable cutting machine as viewed in the direction indicated by arrow X in FIG. 9.

FIG. 11 is a rear view of a battery mount.

FIG. 12 is a horizontal sectional view of a detachment operation unit taken along line XII-XII in FIG. 4 as viewed in the direction indicated by arrows.

FIG. 13 is a longitudinal sectional view of the portable cutting machine taken along line XIII-XIII in FIG. 4 as viewed in the direction indicated by arrows.

FIG. 14 is a right side view of the portable cutting machine with a cutting machine body displaced upward relative to the base to minimize the depth of a cut.

FIG. 15 is a horizontal sectional view of a second engagement portion taken along line XV-XV in FIG. 4 as viewed in the direction indicated by arrows.

### DETAILED DESCRIPTION

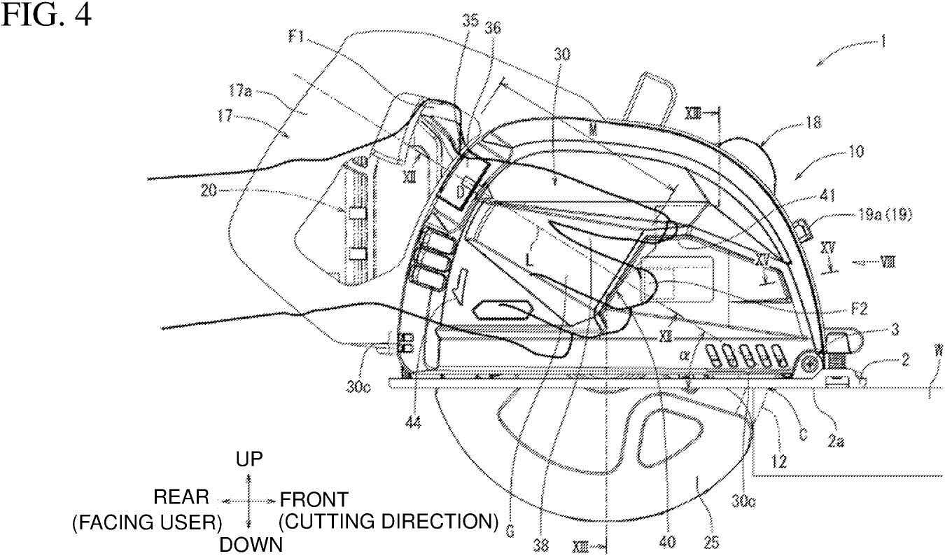

A portable cutting machine according to an embodiment is a handheld cutter called a metal cutter. A metal cutter is mainly used to cut, for example, metal materials such as metal pipes and pultruded aluminum materials. As shown in FIGS. 4, 8, 9, and 10, a portable cutting machine 1 according to the present embodiment includes a base 2 and a cutting machine body 10. The base 2 is a rectangular flat plate and is placed in contact with an upper surface of a workpiece W. The cutting machine body 10 is supported on an upper surface of the base 2. The cutting machine body 10 is supported by the base 2 in a vertically pivotable manner with a support shaft 3. The depth of a cut with the blade 12 is adjustable by changing the vertical position of the cutting machine body 10 relative to the base 2. An adjuster for adjusting the depth of the cut will be described later.

The cutting machine body 10 includes a circular blade 12 rotatable by an electric motor 11. The blade 12 is, for example, a circular saw blade called a tipped saw blade. The electric motor 11 and the blade 12 are supported on a main housing 13. The main housing 13 supports the electric motor 11 on its left side. The electric motor 11 is a direct current (DC) brushless motor that operates on a DC power supply.

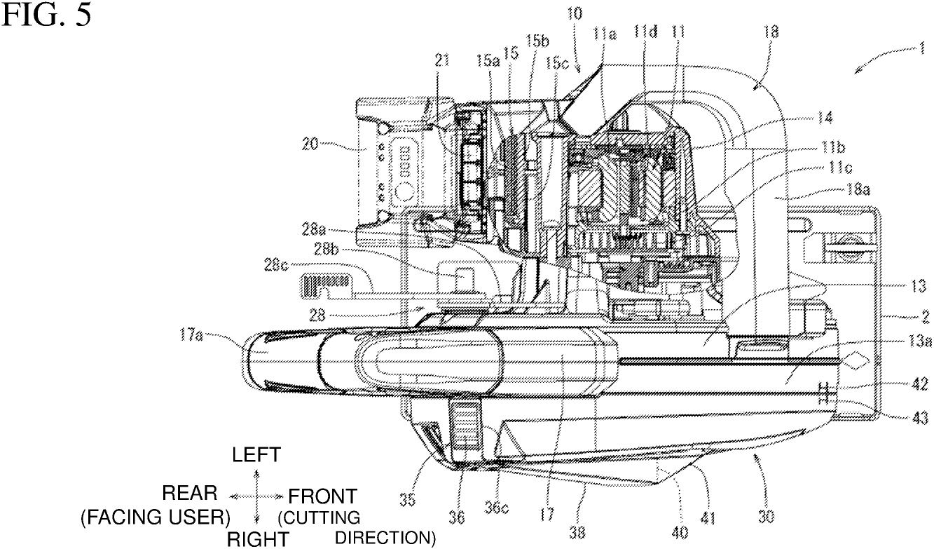

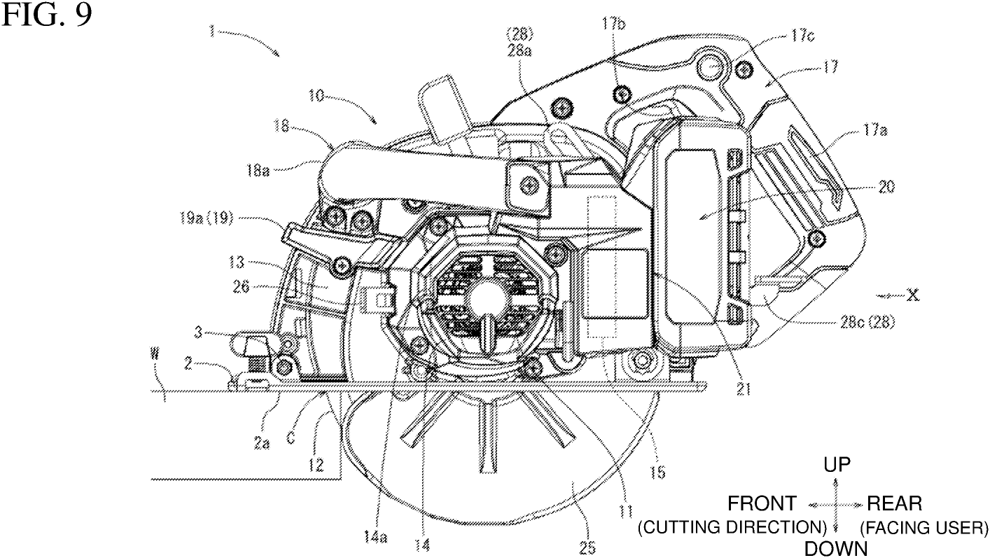

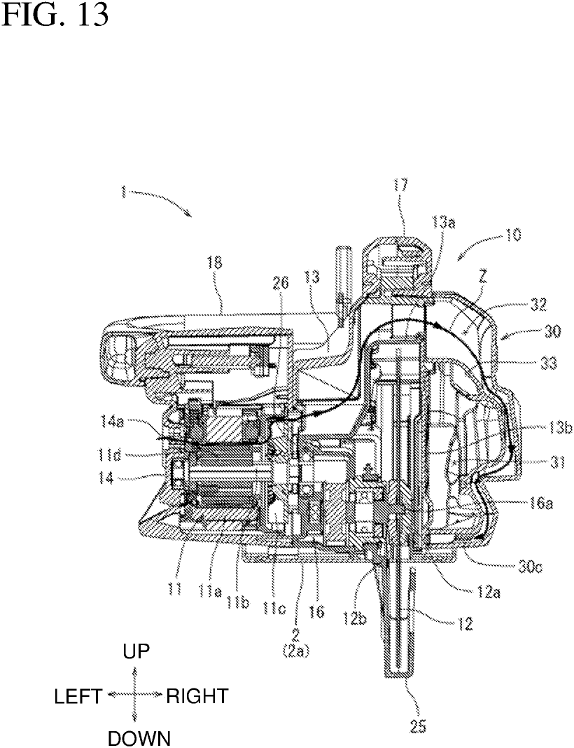

As shown in FIGS. 5 and 13, the electric motor 11 is accommodated in a cylindrical motor housing 14. A stator 11a is attached along the inner surface of the motor housing 14. A rotor 11d is supported in a rotatable manner circumferentially inward from the stator 11a with a motor shaft 11b. A single cooling fan 11c is attached to the motor shaft 11b. As shown in FIGS. 9 and 13, the motor housing 14 has multiple inlets 14a in its left end face. When the cooling fan 11c rotates, outside air is drawn into the motor housing 14 through the inlets 14a. The drawn outside air cools the electric motor 11.

As indicated by the bold arrow in FIG. 13, motor-cooling air Z for cooling the electric motor 11 flows through the main housing 13 into a dust case 30. This will be described in detail later.

The motor shaft 11b is connected to a reduction gear train 16. The reduction gear train 16 includes a spindle 16a that protrudes into a stationary cover 13a. In the stationary cover 13a, the blade 12 is attached to the spindle 16a. The blade 12 sandwiched in the thickness direction between an outer flange 12a and an inner flange 12b is attached to the spindle 16a. The rotational output from the electric motor 11 is reduced by the reduction gear train 16 and is output to the spindle 16a. This causes the blade 12 to rotate.

As shown in FIG. 9, a spindle lock lever 26 is located near the connection between the electric motor 11 and the reduction gear train 16. When, for example, the spindle lock lever 26 is pushed in, the spindle lock lever 26 is engaged with the motor shaft 11b to lock the spindle 16a in a nonrotatable manner. This increases the convenience in the tightening and loosening of fixing screws for attaching and detaching the blade 12 to and from the spindle 16a.

The stationary cover 13a extends outward to surround the blade 12 mainly along the upper half circumference of the blade 12. The blade 12 includes a lower portion protruding toward a lower surface 2a of the base 2. The lower portion of the blade 12 is covered by a movable cover 25. The movable cover 25 can be open and closed along the circumference of the blade 12.

As shown in FIG. 5, a controller 15 is accommodated behind the electric motor 11. The controller 15 includes a control board 15b accommodated in a shallow case 15a, which is insulated with a resin mold 15c. The controller 15 is a substantially rectangular flat plate. As shown in FIGS. 5, 6, and 9, the controller 15 is accommodated vertically to have the thickness direction being the front-rear direction.

The control board 15b in the controller 15 receives a control circuit. The control circuit includes a microcomputer that transmits control signals based on positional information about the rotor 11d detected by a sensor board included in the electric motor 11. The control board 15b also receives a drive circuit. The drive circuit includes a field-effect transistor (FET) that switches a current flowing through the electric motor 11 in response to a control signal received from the control circuit. The control board 15b receives an automatic stop circuit. The automatic stop circuit cuts power supply to the electric motor 11 to avoid overdischarge or overcharge based on the detection result of the battery pack 20.

A battery mount 21 is located behind the controller 15. The battery mount 21 receives a single battery pack 20. The electric motor 11 is powered by the battery pack 20 mounted on the battery mount 21.

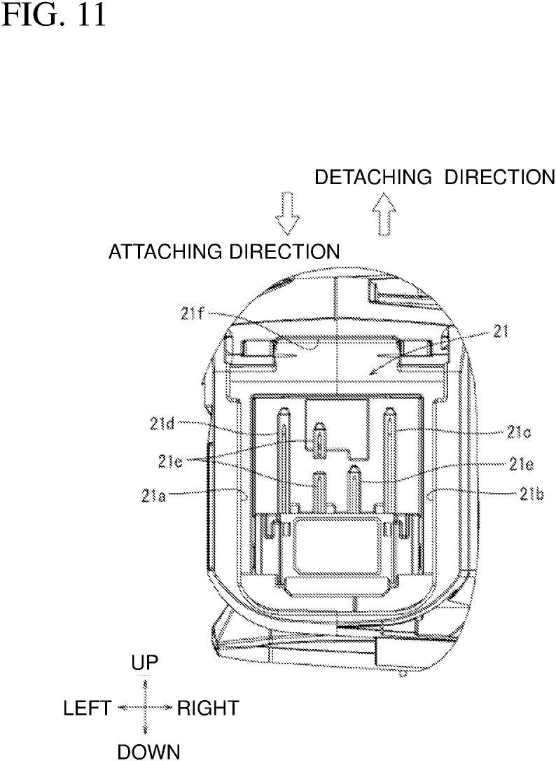

The battery pack 20 is attached to the battery mount 21 in a slidable manner. As shown in FIG. 11, the battery mount 21 includes a pair of left and right rails 21a and 21b. The left and right rails 21a and 21b extend vertically. A positive terminal 21c and a negative terminal 21d are located between the left and right rails 21a and 21b. The positive terminal 21c and the negative terminal 21d extend vertically. A control terminal 21e for control signals is located between the positive terminal 21c and the negative terminal 21d. The battery mount 21 includes a tab engagement portion 21f in its upper portion. With its lock tab engaged with the tab engagement portion 21f, the battery pack 20 is locked on the battery mount 21.

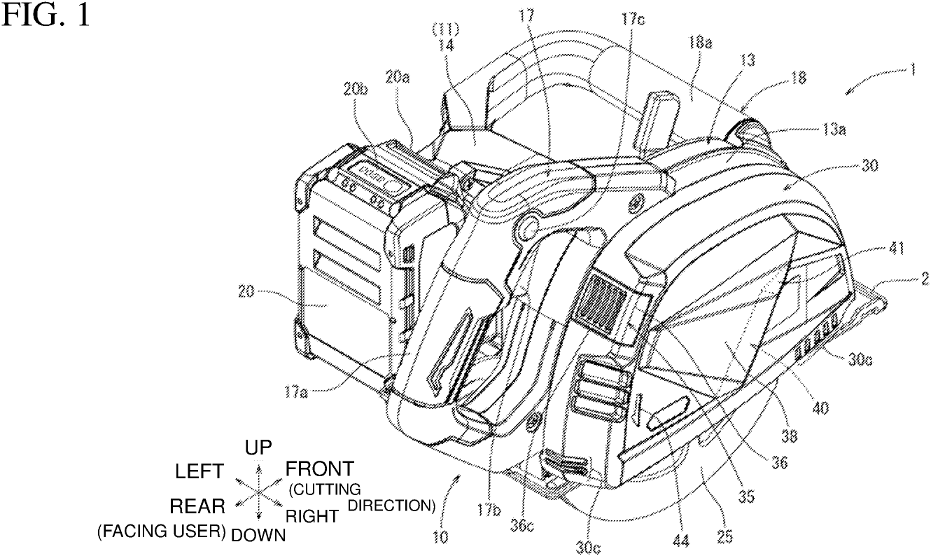

As shown in FIGS. 1, 2, and 6, the battery pack 20 includes a single push button 20a in its upper portion. When the push button 20a is pressed in, the lock tab is disengaged from the tab engagement portion 21f. This unlocks the battery pack 20 and allows the battery pack 20 to slide upward. The battery pack 20 includes a remaining power level display 20b on its upper surface.

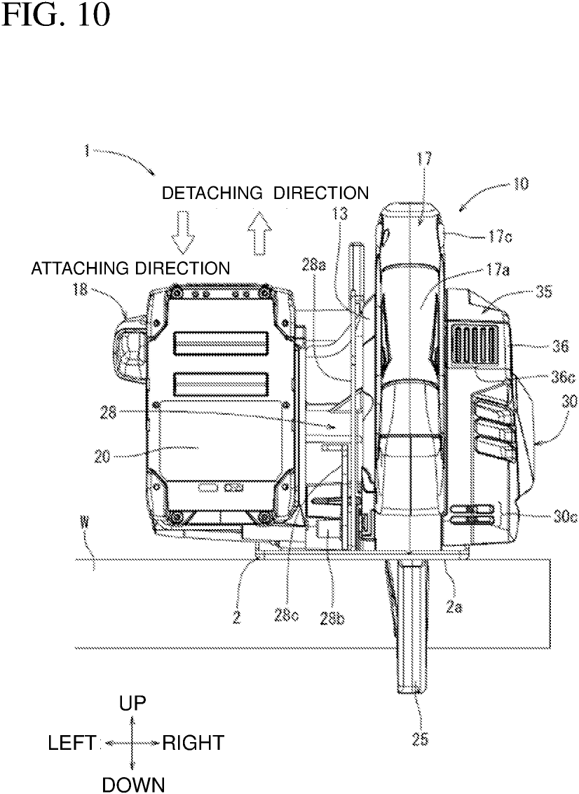

As shown in FIG. 10, the battery pack 20 is slid downward along the left and right rails 21a and 21b with its rail receiver engaged with the rails. This mechanically connects the battery pack 20 to the battery mount 21. The battery pack 20 is thus electrically connected to the battery mount 21. The battery pack 20 is detached from the battery mount 21 when slid upward with the push button 20a being pressed.

The main housing 13 has a handle 17 and a front grip 18 grippable by a user. As shown in FIGS. 1, 2, 4, and 9, the handle 17 is looped vertically and extends from an upper portion to a rear portion of the main housing 13. The handle 17 includes a grip portion 17a with its upper portion inclined frontward. The handle 17 has its outer surface coated with an elastomer resin layer. This prevents the grip portion 17a from slipping and enhances the easiness of gripping.

The handle 17 includes a trigger 17b on its upper inner periphery. The handle 17 includes a switch body (not shown) behind the trigger 17b. The trigger 17b is pulled with a fingertip of a hand holding the grip portion 17a to drive the electric motor 11, which then rotates the blade 12. Above the trigger 17b, lock-off buttons 17c are located on both sides of the upper portion of the handle 17. The trigger 17b can be pulled when the lock-off buttons 17c are pressed. The trigger 17b cannot be pulled when the lock-off buttons 17c are not pressed. The electric motor 11 is thus locked in an off-state.

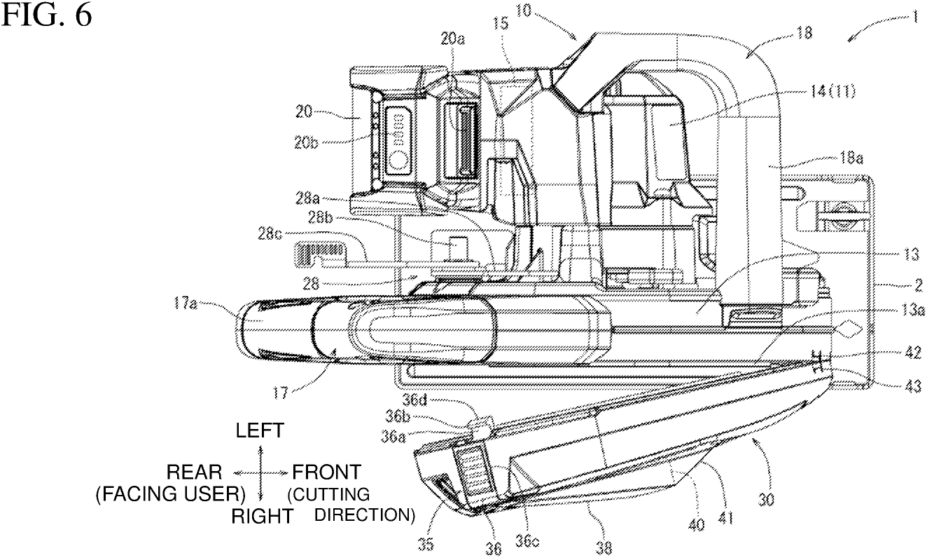

As shown in FIGS. 5 and 6, the front grip 18 is looped laterally and extends from a front portion of the main housing 13 to a rear portion of the motor housing 14. The front grip 18 includes a grip portion 18a extending in the lateral direction that is substantially perpendicular to the cutting direction. For example, the user grips the grip portion 17a of the handle 17 with the right hand and the grip portion 18a of the front grip 18 with the left hand. This allows the portable cutting machine 1 to be moved in the cutting direction in a stable posture.

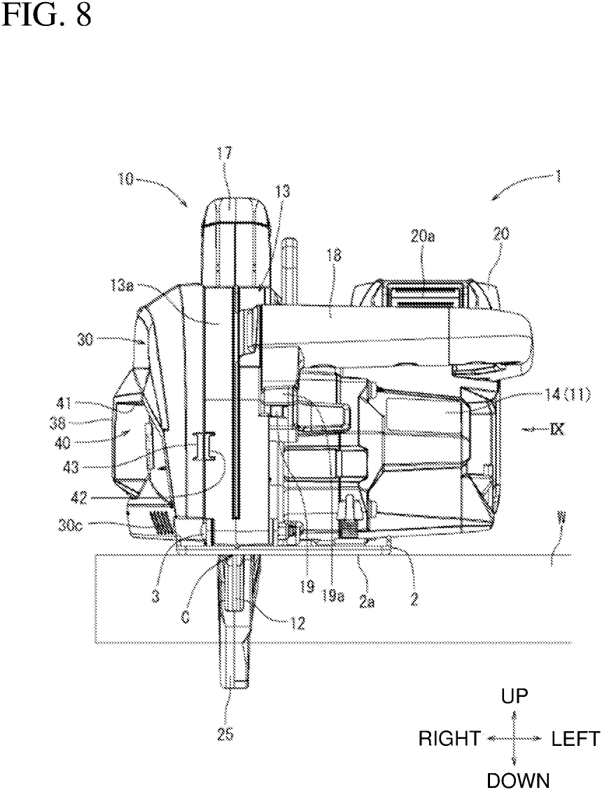

As shown in FIGS. 8 and 9, an illuminator 19 is located at the front of the main housing 13. An arm 19a protrudes frontward from the front portion of the main housing 13 below the front grip 18. The illuminator 19 is accommodated in the distal end of the arm 19a. The illuminator 19 brightly illuminates a cutting portion C (the cutting edge of the blade 12). This increases the convenience in, for example, a cutting operation in a dark place.

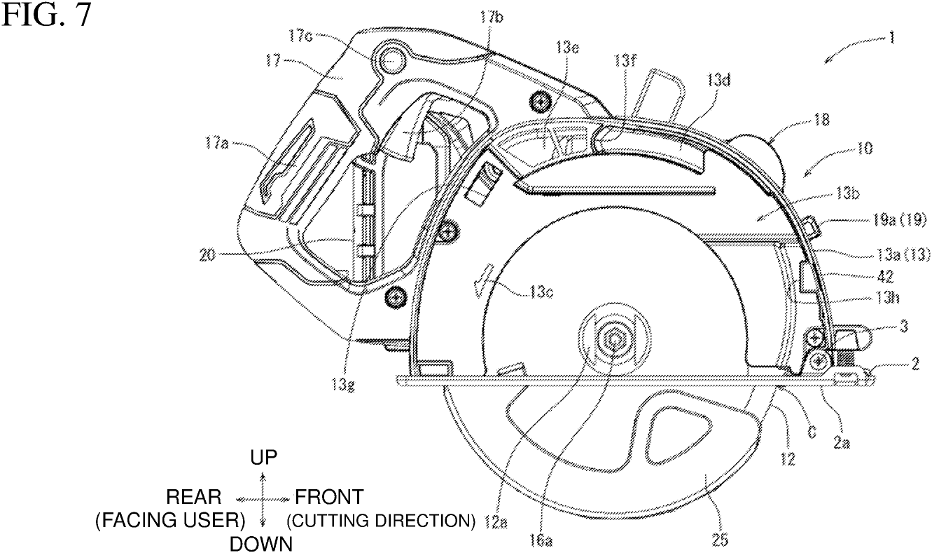

The single dust case 30 is attached on the right side of the main housing 13. The dust case 30 is attached along the stationary cover 13a. As shown in FIG. 7, the stationary cover 13a includes a dust collection wall 13b formed from die-cast magnesium that blocks a portion rightward from the blade 12. The dust collection wall 13b has an arc shape along a substantially upper half circumference of the blade 12. The dust collection wall 13b shows an arrow 13c indicating the direction of rotation of the blade 12. The dust case 30 includes a dust collector 31 to store dust and a ventilation portion 32 exposed on an outer surface. The dust collector 31 is formed from die-cast magnesium. The ventilation portion 32 is formed from a synthetic resin.

A cutting process yields dust blown upward from the cutting portion C. The dust is blown upward inside (on the left of) the dust collection wall 13b. The dust blown upward flows in the counterclockwise direction in FIG. 7 while being carried by the airflow generated by the rotation of the blade 12. The dust collection wall 13b has a missing upper portion. This structure allows the stationary cover 13a to have two openings 13d and 13e in its upper portion. The openings 13d and 13e are separated by a shielding wall 13f. The dust flows into the dust case 30 through the front opening 13d. The motor-cooling air flows into the dust case 30 through the rear opening 13e.

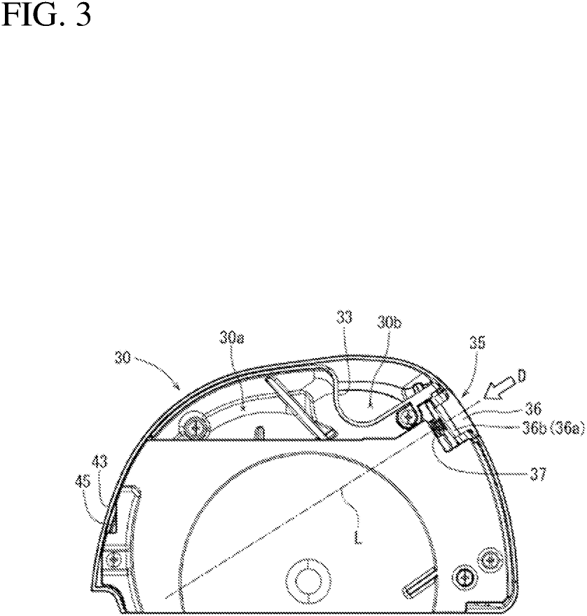

As shown in FIGS. 3 and 13, the dust case 30 includes a substantially semicircular box. The interior of the dust case 30 is divided into the dust collector 31 and the ventilation portion 32 by a partition wall 33. The dust case 30 has two openings 30a and 30b in an upper portion of the inner surface. The openings 30a and 30b are divided by the partition wall 33. The front opening 30a connects to the dust collector 31. The rear opening 30b connects to the ventilation portion 32. With the dust case 30 attached along the stationary cover 13a, the front opening 30a connects to the opening 13d in the stationary cover 13a, and the rear opening 30b connects to the opening 13e in the stationary cover 13a.

Dust that flows along the dust collection wall 13b as being carried by the blow from the rotating blade 12 flow into the dust collector 31 through the openings 13d and 30a. The dust collected in the dust collector 31 is removed through the opening 30a when the dust case 30 is detached from the stationary cover 13a. For example, the dust may be removed through a separate lid to be open and closed in a rear portion of the dust collector 31.

The motor-cooling air flows through the openings 13e and 30b into the ventilation portion 32. The motor-cooling air Z that flows into the ventilation portion 32 cools dust collected in the dust collector 31 through the partition wall 33. The ventilation portion 32 has outlets 30c in its lower portion. The outlets 30c are located in the front, lateral, and rear portions of the dust case 30. The motor-cooling air Z that has cooled the dust is discharged outside through the multiple outlets 30c.

The dust case 30 includes a detachment operation unit 35 and a finger support 40. The detachment operation unit 35 is operated for detachment from the cutting machine body 10. A fingertip is placed in contact with the finger support 40. The detachment operation unit 35 is located at the rear of the dust case 30. The finger support 40 is located substantially in the center of the right side of the dust case 30.

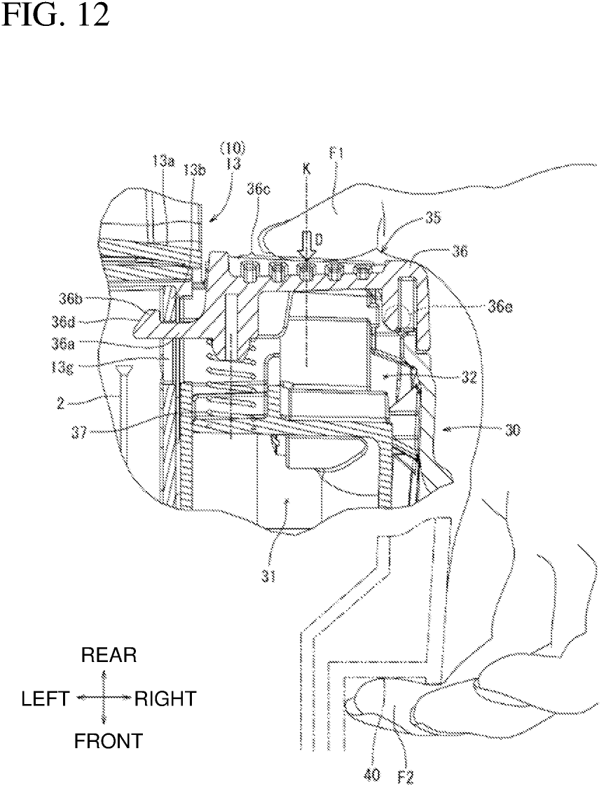

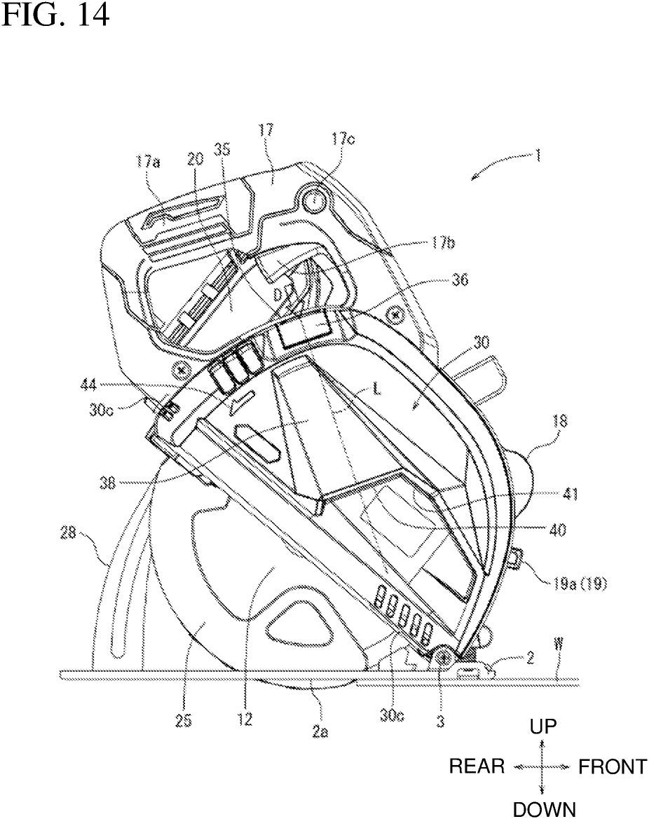

As shown in FIG. 12, the detachment operation unit 35 includes a rectangular flat push portion 36. As shown in FIGS. 4 and 12, the push portion 36 is pushed and operated by a fingertip F1 (e.g., a thumb). The push portion 36 is operated by pushing along an imaginary plane K parallel to the face of the blade 12. In the present embodiment, the push portion 36 is pushed obliquely downward toward the front. In FIGS. 4 and 12, the pushing direction of the push portion 36 is indicated by arrow D. In the present embodiment, the push portion 36 rotates about a support shaft 36e (refer to FIG. 14) extending in an axial direction perpendicular to an imaginary operation line L in a side view perpendicular to the blade 12. Thus, although the pushing direction D actually changes slightly with an operation, the direction is simply referred to as the pushing direction D without being annotated specifically.

As shown in FIG. 12, the push portion 36 is urged in the direction opposite to the pushing direction by a compression spring 37. The push portion 36 is pushed in the pushing direction D against the compression spring 37. The push portion 36 includes an engagement arm 36a (first engagement portion). The engagement arm 36a protrudes leftward. An engagement tab 36b is located at the distal end of the engagement arm 36a.

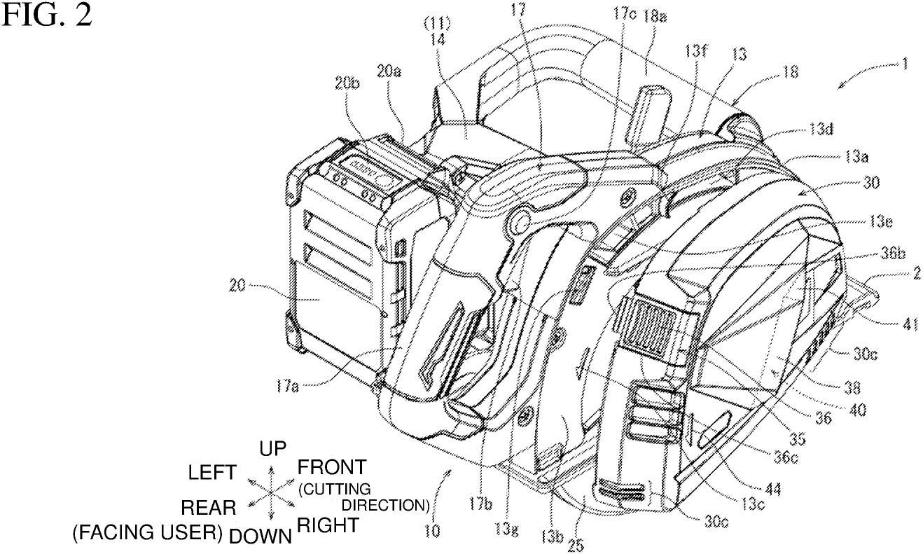

As shown in FIGS. 2, 7, and 12, a rectangular engagement window 13g is located at the rear of the dust collection wall 13b. The dust case 30 has its rear coupled to the cutting machine body 10 as shown in FIGS. 1 and 5 when the engagement tab 36b is hooked on an upper edge of the engagement window 13g. When the push portion 36 is pushed in the pushing direction D, the engagement tab 36b disengages from the engagement window 13g. With the rear of the dust case 30 being displaced to the right, the engagement arm 36a is pulled out of the engagement window 13g. This allows detachment of the rear of the dust case 30 from the cutting machine body 10, as shown in FIGS. 2 and 6.

As shown in FIG. 12, the push portion 36 has a recess on its upper surface that is deeper toward the blade 12. The upper surface of the push portion 36 has multiple ridges 36c aligned with one another (in the direction in which the depth varies). Each ridge 36c extends vertically. This allows the fingertip F1 to easily apply a force in the detaching direction (rightward) to the push portion 36.

The engagement tab 36b has a slope 36d on its left portion. When the dust case 30 is attached, the slope 36d comes in contact with an upper portion of the engagement window 13g to depress the engagement arm 36a. This causes the push portion 36 to be depressed against the compression spring 37. Thus, when the dust case 30 is attached, the rear of the dust case 30 is coupled to the cutting machine body 10 with the engagement arm 36a engaged with the engagement window 13g without the push portion 36 being pushed with the fingertip F1.

As shown in FIG. 4, the finger support 40 is located frontward from the detachment operation unit 35 in the pushing direction D. The dust case 30 includes a step 38 on the right side. The step 38 is located along the imaginary operation line L (imaginary line extending in the pushing direction D) in an area extending from near the detachment operation unit 35 to near the center of the right side. The step 38 has a trapezoidal shape with the vertical width increasing obliquely downward toward the front in a side view and a trapezoidal cross section. The front end of the step 38 is a wall surface perpendicular to the surface direction of the blade 12. The wall surface at the front end serves as the finger support 40. In detaching the dust case 30, a fingertip F2 (e.g., a middle finger) is placed in contact with the finger support 40. Two fingertips (e.g., an index finger and a middle finger) may be placed in contact with the finger support 40.

The finger support 40 extends in a direction perpendicular to the imaginary operation line L. In the present embodiment, the finger support 40 is frontward and at a distance of 110 mm from the detachment operation unit 35 along the imaginary operation line L. The distance (110 mm) from the detachment operation unit 35 to the finger support 40 can be changed within a range of ±10 mm. The distance (110 mm) from the detachment operation unit 35 to the finger support 40 is set within 80 to 120% of the radius of the blade 12. In the present embodiment, the blade 12 has a diameter of 185 mm and a radius of 92.5 mm. The distance is set to 110 mm based on 92.5 mm × 119% = 110 mm. The distance from the detachment operation unit 35 to the finger support 40 can be changed within a range of 80 to 120% of the radius of the blade 12.

The finger support 40 is formed on a flat end face that is 50 mm long in the direction perpendicular to the imaginary operation line L in a side view perpendicular to the blade 12 and 20 mm wide in the direction perpendicular to the surface of the blade 12. The finger support 40 can be changed to be 40 to 60 mm long in the direction perpendicular to the imaginary operation line L in a side view perpendicular to the blade 12, and to be 15 to 25 mm wide in the direction perpendicular to the surface of the blade 12.

The finger support 40 includes, in its upper portion, a vertical wall 41 extending in the direction perpendicular to the surface of the blade 12. The vertical wall 41 regulates any upward positional deviation of the fingertip F2. The dust case 30 is held with the step 38 between the fingertip F1 in contact with the detachment operation unit 35 and the fingertip F2 in contact with the finger support 40. The dust case 30 can thus be held by the two fingertips F1 and F2 for detachment.

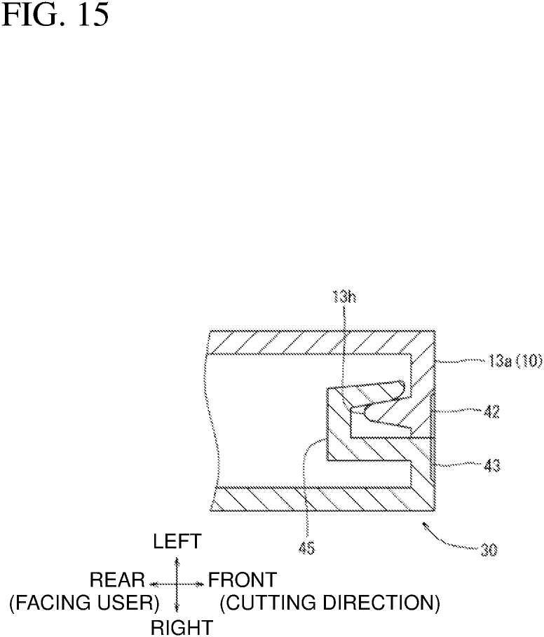

As shown in FIG. 3, the dust case 30 has a single engagement recess 45 (second engagement portion) on an inner surface (left side) of its front. As shown in FIG. 7, an engagement protrusion 13h is located on the front of the stationary cover 13a. As shown in FIG. 15, the engagement recess 45 is placed under the stationary cover 13a, and the engagement protrusion 13h is placed into the engagement recess 45. This couples the front of the dust case 30 to the cutting machine body 10. The rear of the dust case 30 is then coupled to the cutting machine body 10 with the engagement arm 36a in the detachment operation unit 35 pushed into the engagement window 13g.

As shown in FIG. 8, a mark 42 is located on the front surface of the stationary cover 13a. A mark 43 is located on the front surface of the dust case 30. The marks 42 and 43 are recesses in the shape of the letter H rotated 90° sideways. The marks 42 and 43 are indicated as appropriate for the vertical size (actual size) and the position of the engagement protrusion 13h. When the front of the dust case 30 is placed under the stationary cover 13a to have the marks 42 and 43 aligned vertically, the engagement protrusion 13h is placed into the engagement recess 45. This allows an efficient and quick coupling of the front of the dust case 30 to the cutting machine body 10. In the present embodiment, the marks 42 and 43 are recesses. The user can thus notice the marks 42 and 43 by touching with fingertips, without looking into the front of the dust case 30. This increases the convenience in attaching the dust case 30.

As shown in FIG. 3, the engagement recess 45 (second engagement portion) is located above and off the imaginary operation line L.

The dust case 30 shows an arrow 44 indicating the direction of rotation of the blade 12 on its right side.

The portable cutting machine 1 includes a depth adjuster 28 for adjusting the depth of a cut. As shown in FIGS. 5, 6, and 10, a fixing screw 28b is screwed into the left side of the main housing 13. The fixing screw 28b is placed in a slot in an arc-shaped depth guide 28a. The depth guide 28a is supported on the upper surface of the base 2 in a manner tiltable forward and rearward. A lever 28c is coupled to the fixing screw 28b. As the lever 28c is pivoted upward and downward, the fixing screw 28b rotates in the tightening direction or the loosening direction.

The fixing screw 28b is loosened to cause the cutting machine body 10 to pivot upward and downward about the support shaft 3. This changes the dimension by which the blade 12 protrudes toward the lower surface 2a of the base 2 (the depth of the cut into the workpiece W). For example, when the lever 28c is pivoted downward, the fixing screw 28b is screwed into the main housing 13. This fixes the position of the depth guide 28a relative to the cutting machine body 10 and the vertical position of the cutting machine body 10 relative to the base 2. This fixes the depth of the cut with the blade 12.

At the top dead center of the cutting machine body 10 as shown in FIG. 14, the depth of the cut with the blade 12 is at its minimum. At the bottom dead center of the cutting machine body 10 as shown in FIG. 4, the depth of the cut with the blade 12 is at its maximum. With the cutting machine body 10 positioned at the bottom dead center, the imaginary operation line L extending along the pushing direction D of the detachment operation unit 35 is inclined at about 30° relative to the lower surface 2a of the base 2. The inclination angle α of the imaginary operation line L (pushing direction D) can be changed in a range of 20 to 40°.

As shown in FIG. 4, an area center (geometric center) G of the dust case 30 in a side view perpendicular to the blade 12 is located within the area bounded by the detachment operation unit 35 and the finger support 40. The relative position of the finger support 40 to the detachment operation unit 35 is set as appropriate to cause the area center G to be between the detachment operation unit 35 and the finger support 40. The area center G substantially matches the center of gravity of the dust case 30, although the area center G can vary depending on the amount of dust collected in the dust collector 31. Thus, the area center G is located between the detachment operation unit 35 and the finger support 40 to further improve the weight balance in gripping the dust case 30 with the two fingertips F1 and F2.

The detachment operation unit 35 and the finger support 40 are located on the imaginary operation line L. The imaginary operation line L crosses the grip portion 17a of the handle 17 that is behind the detachment operation unit 35 in a side view. The detachment operation unit 35, the finger support 40, and the grip portion 17a are aligned on the single imaginary operation line L. This allows, for example, the thumb F1 and the middle finger F2 of the right hand to be in contact with the detachment operation unit 35 and the finger support 40 in a comfortable posture when the dust case 30 are attached or detached with the grip portion 17a held by the left hand. This further improves the operability in attaching and detaching the dust case 30.

The portable cutting machine 1 according to the embodiment includes the dust case 30 detachably attached to the cutting machine body 10. The dust case 30 includes the detachment operation unit 35 that is pushed along the imaginary plane K parallel to the surface of the blade 12 in detachment from the cutting machine body 10, and the finger support 40 that includes a surface frontward from the detachment operation unit 35 in the pushing direction D in which the detachment operation unit 35 is pushed. The surface is substantially perpendicular to the pushing direction D.

Thus, the dust case 30 can be detached with the two fingertips F1 and F2 holding the detachment operation unit 35 and the finger support 40. This improves the operability in attaching and detaching the dust case 30. In particular, the finger support 40 is located frontward from the detachment operation unit 35 in the pushing direction D, thus allowing the push portion 36 to be pushed while the push portion 36 and the finger support 40 are being held. This specifically improves the operability for detachment.

In the embodiment, the dust case 30 has, in a side view perpendicular to the blade 12, the area center G located between the detachment operation unit 35 and the finger support 40. This facilitates gripping of the dust case 30. In particular, the center of gravity is near the area center G in a side view to improve the weight balance in, for example, gripping the dust case 30 in a horizontal posture with the side surface facing upward.

The portable cutting machine 1 according to the embodiment includes the depth adjuster 28 that adjusts the position of the cutting machine body 10 relative to the base 2 between the top dead center and the bottom dead center. With the cutting machine body 10 positioned at the bottom dead center, the imaginary operation line L extending in the pushing direction D of the detachment operation unit 35 is inclined at an angle of about 30° relative to the lower surface 2a of the base 2. This allows the user to easily apply a pushing force to the push portion 36 of the detachment operation unit 35.

The portable cutting machine 1 according to the embodiment includes the engagement arm 36a (first engagement portion) and the engagement recess 45 (second engagement portion) to cause the dust case 30 to be engaged with the cutting machine body 10. The engagement arm 36a is located on the detachment operation unit 35. The engagement recess 45 is located above and off the imaginary operation line L in a side view perpendicular to the blade 12. This allows the user to easily view the engagement recess 45 from obliquely upward at the rear, thus improving the operability in attaching and detaching the dust case 30.

In the embodiment, the length M from the detachment operation unit 35 to the finger support 40 is 80 to 120% of the radius of the blade 12. The length M may be 100 to 120 mm. This facilitates gripping of the dust case 30.

The detachment operation unit 35 in the embodiment includes the push portion 36 being a recess in the pushing direction D. This allows a pushing force in the pushing direction D to be applied easily to the push portion 36. The recess allows the push portion 36 to be noticed by the user touching the recess with the fingertip F1, which improves the operability of the push portion 36.

In the embodiment, the upper surface of the push portion 36 has a recess being deeper toward the blade 12. This allows a pushing force in the detaching direction to be applied easily to the push portion 36 when the push portion 36 is positioned above the blade 12.

The finger support 40 in the embodiment has a length of 40 to 60 mm in a side view perpendicular to the blade 12. The finger support 40 is a flat surface with a length of 15 to 25 mm in the direction perpendicular to the surface of the blade 12. This allows the dust case 30 to be gripped with the fingertip F2 that is reliably pressed against the finger support 40.

In the embodiment, the finger support 40 includes, in its upper portion, the vertical wall 41 extending in the direction perpendicular to the surface of the blade 12. This prevents the fingertip F2 from slipping off the finger support 40, thus improving the gripping of the finger support 40.

In the embodiment, the imaginary operation line L of the detachment operation unit 35 extends through the grip portion 17a of the handle 17. This structure improves the operability in, for example, attaching and detaching the dust case 30 with the right hand while the grip portion 17a is being gripped with the left hand.

In the embodiment, the mark 43 on the front surface of the dust case 30 indicates the position of the engagement recess 45 (second engagement portion). The mark 42 is on the front surface of the stationary cover 13a. The user can readily place the engagement protrusion 13h into the engagement recess 45 by aligning the mark 43 with the mark 42. This increases the convenience in attaching the dust case 30.

The embodiments described above may be modified variously. For example, the vertical wall 41 may be eliminated. The recess and protrusion relationship between the engagement recess 45 (second engagement portion) and the engagement protrusion 13h on the cutting machine body 10 may be reversed.

The user can place any fingertips in contact with the detachment operation unit 35 and the finger support 40. For example, the dust case 30 may be attached and detached with the middle finger F2 in contact with the detachment operation unit 35 and the thumb F1 in contact with the finger support 40.

Although the finger support 40 is a wall surface flat in the direction perpendicular to the imaginary operation line L in the above example, the finger support may be a curved surface that is recessed gently toward the detachment operation unit 35. This structure reduces misplacement of fingers and improves gripping.

Although the portable cutting machine 1 is a metal cutter in the above example, the detachment operation unit 35 and the finger support 40 in one or more embodiments of the present disclosure may be used for a portable circular saw with a dust case (dust box), such as a dust-proof circular saw. Although the dust case has an upper opening that remains open in the above example, the dust case may instead be a dust box without an upper opening.

### REFERENCE SIGNS LIST

1 portable cutting machine
2 base
2a lower surface
3 support shaft
10 cutting machine body
11 electric motor
11a stator
11b motor shaft
11c cooling fan
11d rotor
12 blade
12a outer flange
12b inner flange
13 main housing
13a stationary cover
13b dust collection wall
13c arrow (rotation direction of blade 12)
13d opening (for dust)
13e opening (for motor-cooling air)
13f shielding wall
13g engagement window
14 motor housing
14a inlet
Z cooling air
15 controller
15a case
15b control board
15c resin mold
16 reduction gear train
16a spindle
17 handle
17a grip portion
17b trigger
17c lock-off button
18 front grip
18a grip portion
19 illuminator
19a arm
C cutting portion
20 battery pack
20a push button
20b remaining power level display
21 battery mount
21a, 21b rail
21c positive terminal
21d negative terminal
21e control terminal
21f tab engagement portion
25 movable cover
26 spindle lock lever
28 depth adjuster
28a depth guide
28b fixing screw
28c lever
30 dust case
30a opening (for dust)
30b opening (for motor-cooling air)
30c outlet
31 dust collector
32 ventilation portion
33 partition wall
35 detachment operation unit
36 push portion
36a engagement arm (first engagement portion)
36b engagement tab
36c ridge
36d slope
36e support shaft
37 compression spring
38 step
40 finger support
F1 fingertip (thumb)
F2 fingertip (middle finger)
D pushing direction
K imaginary plane
L imaginary operation line
G area center (geometric center)
M length from detachment operation unit 35 to finger support 40
41 vertical wall
42 mark (engagement protrusion 13h)
43 mark (engagement recess 45)
44 arrow (rotation direction of blade 12)
45 engagement recess (second engagement portion)

What is claimed is:

1. A portable cutting machine, comprising:
a cutting machine body to which a blade being circular is attachable; and
a dust case detachably attached to the cutting machine body, the dust case including
a detachment operation unit pushable along an imaginary plane parallel to a surface of the blade in detachment from the cutting machine body, and
a finger support including a surface frontward from the detachment operation unit in a pushing direction in which the detachment operation unit is pushed, the surface being substantially perpendicular to the pushing direction.

2. The portable cutting machine according to claim 1, wherein
the dust case has, in a side view perpendicular to the blade, an area center between the detachment operation unit and the finger support.

3. The portable cutting machine according to claim 1, further comprising:
a base having a lower surface to be in contact with a workpiece; and
a depth adjuster configured to adjust a position of the cutting machine body relative to the base between a top dead center and a bottom dead center,
wherein with the cutting machine body positioned at the bottom dead center, an imaginary operation line extending in the pushing direction of the detachment operation unit is inclined at an angle of 20 to 40° relative to the lower surface of the base.

4. The portable cutting machine according to claim 1, further comprising:
a first engagement portion and a second engagement portion configured to cause the dust case to be engaged with the cutting machine body,
wherein the first engagement portion is located on the detachment operation unit, and
the second engagement portion is, in a side view perpendicular to the blade, located off an imaginary operation line extending in the pushing direction of the detachment operation unit.

5. The portable cutting machine according to claim 1, wherein
a length from the detachment operation unit to the finger support is 80 to 120% of a radius of the blade.

6. The portable cutting machine according to claim 5, wherein
the length from the detachment operation unit to the finger support is 100 to 120 mm.

7. The portable cutting machine according to claim 1, wherein
the detachment operation unit includes a push portion being a recess in the pushing direction.

8. The portable cutting machine according to claim 7, wherein
the push portion is a recess being deeper toward the blade.

9. The portable cutting machine according to claim 1, wherein
the finger support has a length of 40 to 60 mm in a side view perpendicular to the blade and a length of 15 to 25 mm in a direction perpendicular to the surface of the blade.

10. The portable cutting machine according to claim 1, wherein
the finger support includes a vertical wall in an upper portion of the finger support, and the vertical wall extends in a direction perpendicular to the surface of the blade.

11. The portable cutting machine according to claim 1, wherein
the cutting machine body includes a handle, and
an imaginary operation line extending in the pushing direction of the detachment operation unit extends through a grip portion of the handle.

12. The portable cutting machine according to claim 1, further comprising:
a first engagement portion and a second engagement portion configured to cause the dust case to be engaged with the cutting machine body,
wherein the first engagement portion is at a rear of the dust case in a direction of cutting,
the second engagement portion is at a front of the dust case in the direction of cutting, and
the dust case includes a mark on a front surface of the dust case, and the mark indicates a position of the second engagement portion.

13. The portable cutting machine according to claim 2, further comprising:
a base having a lower surface to be in contact with a workpiece; and
a depth adjuster configured to adjust a position of the cutting machine body relative to the base between a top dead center and a bottom dead center,
wherein with the cutting machine body positioned at the bottom dead center, an imaginary operation line extending in the pushing direction of the detachment operation unit is inclined at an angle of 20 to 40° relative to the lower surface of the base.

14. The portable cutting machine according to claim 2, further comprising:
a first engagement portion and a second engagement portion configured to cause the dust case to be engaged with the cutting machine body,
wherein the first engagement portion is located on the detachment operation unit, and
the second engagement portion is, in a side view perpendicular to the blade, located off an imaginary operation line extending in the pushing direction of the detachment operation unit.

15. The portable cutting machine according to claim 3, further comprising:
a first engagement portion and a second engagement portion configured to cause the dust case to be engaged with the cutting machine body,
wherein the first engagement portion is located on the detachment operation unit, and
the second engagement portion is, in a side view perpendicular to the blade, located off an imaginary operation line extending in the pushing direction of the detachment operation unit.

16. The portable cutting machine according to claim 2, wherein
a length from the detachment operation unit to the finger support is 80 to 120% of a radius of the blade.

17. The portable cutting machine according to claim 3, wherein
a length from the detachment operation unit to the finger support is 80 to 120% of a radius of the blade.

18. The portable cutting machine according to claim 4, wherein
a length from the detachment operation unit to the finger support is 80 to 120% of a radius of the blade.

19. The portable cutting machine according to claim 2, wherein
the detachment operation unit includes a push portion being a recess in the pushing direction.

20. The portable cutting machine according to claim 3, wherein
the detachment operation unit includes a push portion being a recess in the pushing direction.
